(19) United States
(12) Patent Application Publication
(10) Pub. No.: US 2012/0284528 A1
(43) Pub. Date: Nov. 8, 2012

(54) MULTI-PURPOSE MULTI-DIMENSIONAL, VARIABLE AND MULTI-KEY E-MAIL AND DATA ENCRYPTION METHOD

(76) Inventor: Stephen Orovitz, Ridgefield Park, NJ (US)

(21) Appl. No.: 13/268,090

(22) Filed: Oct. 7, 2011

Related U.S. Application Data
(60) Provisional application No. 61/390,940, filed on Oct. 7, 2010.

(51) Int. Cl. G06F 21/24

(52) U.S. Cl. 713/189

(57) ABSTRACT

A multi-purpose multi-dimensional, variable, and multi-key e-mail and data encryption method is disclosed. The method dynamically encrypts data strings and data files with a set of “n” of keys and dimensions. Keys manipulated and encrypted, prepared keys such as manipulated environmental variables, manipulated date stamps, manipulated user data from a database, using multiple dimensions.

Certain embodiments of the invention include a multi-dimensional computer data encryption/decryption method intended for use as a standalone application, as an application library, or for encrypted communication between one or more networked devices. Each of the various applications of the encryption method may include at least one microprocessor, microprocessor support hardware, optionally at least two network ports for connecting to upstream and downstream network(s), data and memory storage device(s) for storing, programming code, configuration, environmental variables, switches, user specific data and/or key/list data, and (if in more than one location) data encryption/decryption software.

The method dynamically encrypts data strings and/or files with a set of “n” keys and dimensions (where n is an integer number greater than 1). Keys manipulated and encrypted, prepared keys such as manipulated environmental variables, manipulated date stamps, manipulated user provided data from a form or database, using multiple dimensions.

Dimensions may include, but are not limited to, the following encryption methodologies:
1.) Using a key (stored encrypted key and/or application environmental variable(s), and/or user specific data from a form or database) to encode via Cipher Block Chaining (shown in FIG. 1), binary or text data, encoded to a predetermined ASCII alphabet.
2.) Use of regular expressions to replace/substitute set characters with set replacements (key/value pairs) in a set order from the previously encoded initial dimension result. The method is in greater detail in the section “Dimension Character Replacements”.
3.) Optionally encoding input data to BASE64. This method is described in greater detail in the section “Dimension BASE64 Encoding”.
4.) Using different, the same, a combination or manipulated same key/value pair set character substitution on the previous BASE64 encoding. Again using a key (the same user provided, different or a combination key, of an encrypted system and/or application environmental variable(s) and/or user specific data from a database) to encode via Cipher Block Chaining (shown in FIG. 1).
5.) Encoding via another chosen method such as, in Perl for example, “pack”. This encoding technique takes a LIST of values and converts it into a string using the rules given by its TEMPLATE. The resulting string is the concatenation of the converted values. Typically, each converted value looks like its machine-level representation. For example, on 32-bit machines an integer may be represented by a sequence of 4 bytes that will be converted to a sequence of 4 characters.
6.) Reversing the encoded string.

The dimension may be any sequence of any combination of the above listed methods as long as the first dimension encodes with the first key as stated in item 1. That is, the first dimension is designed to encode and encrypt with the first key, using Cipher Block Chaining (especially required for binary files and data).

Optionally, an encrypted reverse order key can be embedded within the encrypted string or file for transport (illustrated in FIG. 3), using a set of location markers based on string/file length and key length variables. Such a key can be embedded within the application, pre-encrypted for storage in a file or database to be called and placed within a string or file. All that is required is the simple length calculation of the reverse order key, and the location placement length (as a marker) within the file.

Decrypting will naturally require the exact reverse dimensional order, and within each dimension, the reverse order and use of keys. If a reverse order key is embedded, from the pre-set length markers, the algorithm shall extract and decode the reverse order key and use it to obtain the dimensional hierarchy with associated keys, and decode the string or file in proper order.

It should be noted when using substitutions on BASE64 encoding, if carefully done, the encoding is not easily detectable due to the recognizable BASE64 “alphabet”. In such cases a new and different substitution dimension key/value pair set are utilized, or by manipulating an existing substitution dimension (by changing key/value pair order). The replacement (substitution key/value pairs) can optionally be hard-coded within the compiled application, pre-encrypted in a reference file or database, or by embedding in an encrypted character and order key (as stated above).

Any order of dimensions can be applied and/or repeated using different keys dynamically from one string/file to another from a pre-encrypted character and order key or keys.

Due to the variable re-use of dimensions, in one embodiment each encoding part is performed by a sub-routine process. In another embodiment all encoding parts are performed by one sub-routine process where each encoding part is called by parameters. A non-limiting flow diagram showing the encryption process is illustrated in FIG. 2.

Each embodiment below occurs at the application layer. This allows for installation ease on almost any platform, with almost any programming language, used for any non networked, or networked device (see, for example, FIG. 4.).

### Utilizing the Encryption Method as a Standalone Application

As a standalone application, the method has its own set of dimensional hierarchies with built-in or externally stored (in an encrypted file or database) key sets. The dimension and key order and/or key mash-up can be applied as stated above, or by the use of switches and/or “key/value pair” variables, utilized by the application. With key/value pairs passed to the application, the method will encrypt with a different dimensional hierarchy each time, based on each key and its value. At least one dimension can be encoded with a key obtained from its local environmental variables such as an IP address, or MAC address, or combination thereof. If, for example, the application is installed for use on a Secure Socket Layer (SSL) server, the remote IP and/or MAC addresses will also be used as key(s) within the dimensional hierarchy, depending on the switch and key value pair referenced for this dimension. For example, if a key starts with a case sensitive letter between v-z, dimensional hierarchy 1 will encrypt the passed key's value. If a file's file name starts with the range A-D, dimensional hierarchy 7 will encrypt the file. Any character array or character range can be used per dimensional hierarchy.

If only a string is passed for encryption, the application will use the 1st (binary or text) character for dimensional hierarchy encoding, based on character range or array.

Output of the data will depend on the switches or key/value pairs used. It can be output to a file, passed to another application for transport or sent back to the waiting, sending application for processing.

If installed on multiple networked devices, the exact same array or character ranges must be set within each application for successful local and remote encryption and decryption. To accomplish this, the same first unencrypted character will be either pre-pended to the encrypted result, or placed within the encrypted result at a set length marker (i.e. inserted into byte 4 of a 1024 length string) by the sending application. In addition, the local (sending) application will use the environmental variable(s) (IP address and/or MAC Address) as one or more keys (depending on the key/value pair or switch installation options). Each application however must be installed with the exact same options.

During the decryption process, the application will decode the string or file (in reverse order) with the local and remote IP and/or MAC addresses used as key(s) during the dimensional encoding process. If successful decryption, it will then match the local and remote IP and/or MAC addresses with the environmental variables before completing the decryption of the data, assisting in the verification of the sending and receiving host.

### Utilizing the Encryption Method as a Called Local Application or Library

In the embodiment the method may use an encrypted (during installation) configuration file. During the initial installation, random installer inserted keys can be applied, plus one or more environmental variables will be set to be used as key(s), including, but not limited to local and remote IP and MAC addresses, date/time stamp and data length (or an application set mixture). An “n” number of keys can added by the installer, and each key can be a varied length of characters (any alphanumeric characters). Also during initial installation, the installer can determine the mapping of the dimensional hierarchy, including the switch or key/value pair mappings and encoding options, or the application can determine its own hierarchy and mappings based on the keys provided. Optionally during installation, the configuration can store an “application determined” mash-up of one or more keys for use in one or more dimensions. The final step in the initial installation is the encryption of the configuration file (or configuration data for database insertion), which includes all of the above stated keys and mappings, unique to its networked device.

For example, at the application layer, a local web based application's state and storage can easily pass application variables (for input/output and optionally added key(s)), a string or file (using file location) to the encryption method. The application will also utilize delimited environmental variables pre-pended to the data feed before encryption for use as state data (including, but not limited to local and remote IP and MAC addresses, date/time stamp and data length). The data then gets multi-dimensionally encoded by using the dimension hierarchy from its encrypted configuration file or source.

Output of the data will depend on variables set, for example, by a web application passing data to the application. The encrypted result can be set to a file, data stream, sent back to the data providing application for state “cookie(s)” and/or other variables. Or, if the data sending application is calling for decryption (by use of sent variables), the decrypted result can be sent back to the sending application as a data stream, state “cookie(s)” and/or file for the providing application to process. Note: In this embodiment, the method is the only point of contact for encryption and decryption, and if used, its encrypted configuration file or source.

### Utilizing the Encryption Method as a Networked Multi-Host Application or Library

This method also can be utilized by almost any programming language, which enables this method to be easily installed in almost any networked device (see, for example, FIG. 4). Usage of this method on multiple networked devices such as routers, switches, servers and PC's, does require a standard for successful two way encryption/decryption communication.

As indicated above, an optional encrypted configuration file or source can be utilized on each host, or preset within the application. However, to successfully communicate (encrypt/decrypt) to a remote host, hosting the same type of encryption method, the configuration file or source must contain the exact same dimensional hierarchy. Local host encoding must include the use of its local IP address, MAC address and/or dually recognizable state variable (between hosts) as a key (or mutually understood key mash-up), used at the same point in the dimensional hierarchy. The destination host application, shall decrypt using the same dimensional hierarchy, utilize the sending host application's IP address (or dually recognizable state variable(s)) as indicated by the dimensional hierarchy, as a key (or mash-up key) according to the application's dimensional hierarchy, or configuration file or source. Therefore, in this embodiment, the application must include the exact same dimensional hierarchy, or an encrypted configuration file or source is required.

In accordance with another embodiment, instead of the encrypted configuration file (or source) containing the dimension hierarchy, key's and individual dimension map, the encrypted configuration file would contain only a set of key/value pair of alphanumeric character references to dimension hierarchies, keys, key mash-ups and/or character substitution dimensions. One key would be used as the “encrypted reverse order dimension mapping key” start point value (see FIG. 3). One key value pair would include an encoding method, one key value pair would reference a character substitution key/value pair and other desired mappings.

In accordance with another embodiment, the “encrypted reverse order dimension mapping key” (FIG. 3) start point value is the start “insertion” point for the “encrypted reverse order dimension mapping key” placed within the encrypted data result. This “key” would include all necessary dimensional hierarchies, mappings, keys and “state” information required for destination decryption.

Each local application can then have its own dynamic set of dimensions and keys. Its keys, dimension hierarchy and individual dimension mapping (as configuration file key value pairs), can all be encrypted, using a commonly used set of dimensional hierarchies. For example, each host's application can decrypt based on the array or character ranges described above, utilizing a set dimensional hierarchy with sending host's IP address and/or MAC address used as encryption keys. Once encrypted, the length value of the “encrypted reverse order dimension mapping key” (FIG. 3) is itself encrypted with the common mapping (between host applications), pre-pended with a configuration file (or source) stored delimiter (as a key/value pair), to the encoded data, while the “encrypted reverse order dimension mapping key” (FIG. 3) is inserted at the start point of the encrypted data, derived from the start point key/value pair form the configuration file.

Within the application, a set of arrays, each with a set of characters, will reference a set of common dimensional hierarchies, with keys (including local and remote environmental variables, used on all networked devices will encrypt the final result. One of the characters within the character range or array will be pre-pended to the final result for transport or export.

For decryption, the received data will then:
1. Use the 1st character to determine the array or character range for common multidimensional decryption of the remainder of multidimensional encrypted data.
2. The length value (encrypted with the starting character range or array based common dimension hierarchy) of the “encrypted reverse order dimension mapping key” (FIG. 3) that is pre-pended with a configuration file stored delimiter, will then be extracted and decrypted.
3. The decrypted reverse order dimension mapping key (FIG. 3) with its embedded keys, will then be used to decrypt the remaining data-set in reverse order, using the sending and local IP/MAC addresses (with any other environmental state data) and other preset keys and dimensions, to decode the data or file.
4. The application will then match the IP and/or MAC addresses with the environmental variables before completing the decryption of the data.

Any of the above options, parts therein, combinations therein or other, can be applied to the encryption method disclosed herein.

Due to the multidimensional use of variable length keys and Cipher Block Chaining (FIG. 1.), the character substitutions, data encodings and/or the variable way to set dimensions, this method provides strong data encryption for almost any type of data, for one or more networked hosts.

Use of common dimensional hierarchies by character ranges or arrays, based on characters, inserting via length and a start point dimensional keys incorporating environmental state data, adds additional powerful encryption strength for data transport, state or storage.

The method and applications disclosed herein are designed for multi-use encryption on almost platform, for almost any purpose. It should be appreciated that the method uses minimal resources, and depending on dimensions and dimensional hierarchy, performs well under heavy use.

### BRIEF DESCRIPTION OF THE DRAWINGS

FIG. 1 is illustrates an optional Dimension Cipher-block chaining (CBC) encryption. The CBC encryption mode of operation was invented by IBM in 1976. In the cipher-block chaining (CBC) mode, each block of text is XORed with the previous cipher-text block before being encrypted. This way, each cipher-text block is dependent on all text blocks processed up to that point. Also, to make each message unique, an initialization vector must be used in the first block.

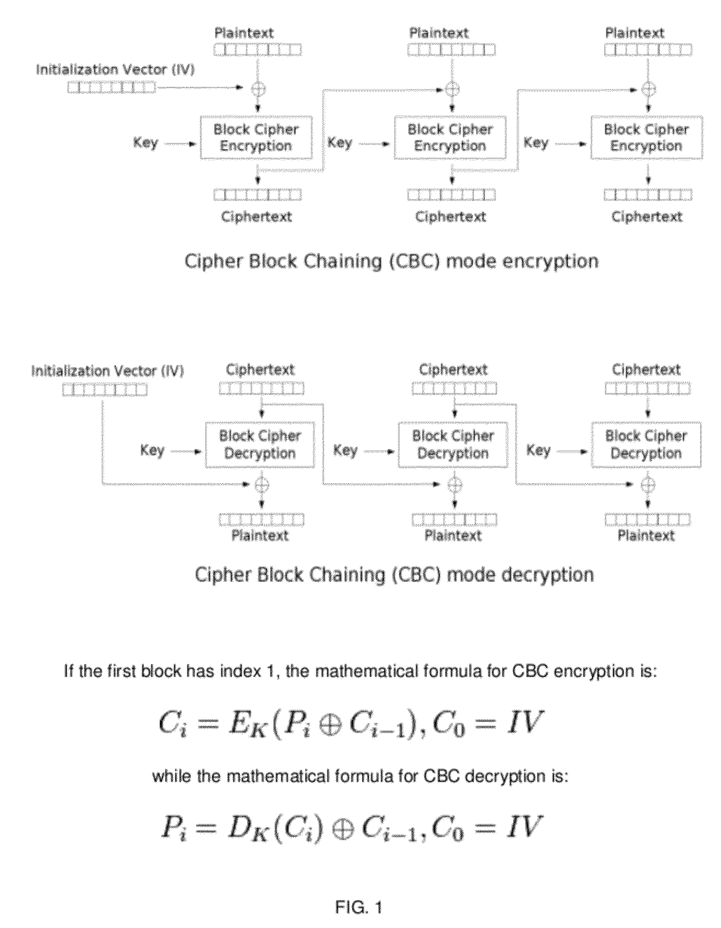

FIG. 2 is a flow diagram illustrating the variable encryption method with 8 dimensions.

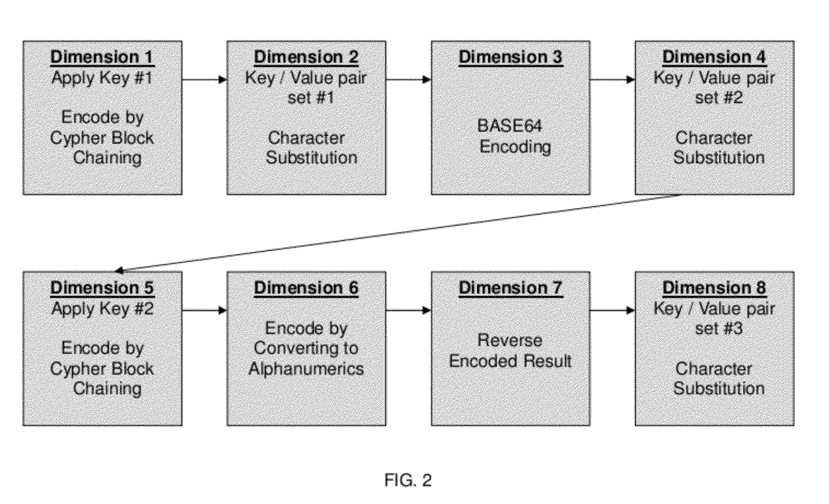

FIG. 3 shows an encrypted reverse order key.

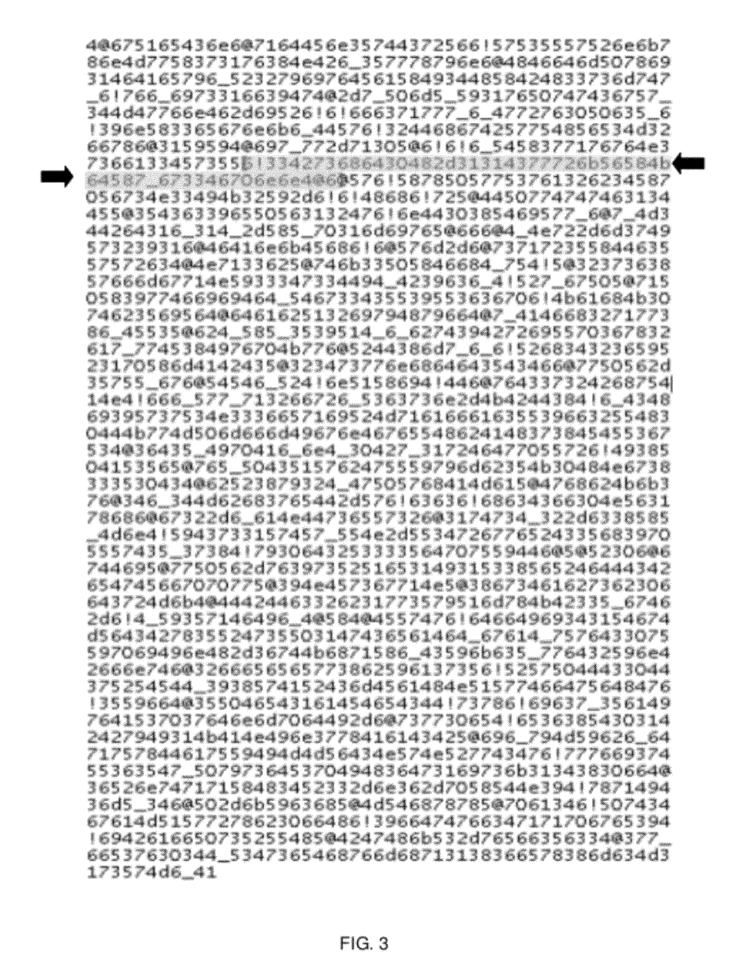

FIG. 4 is a diagram of a network where the encryption technique can be utilized.

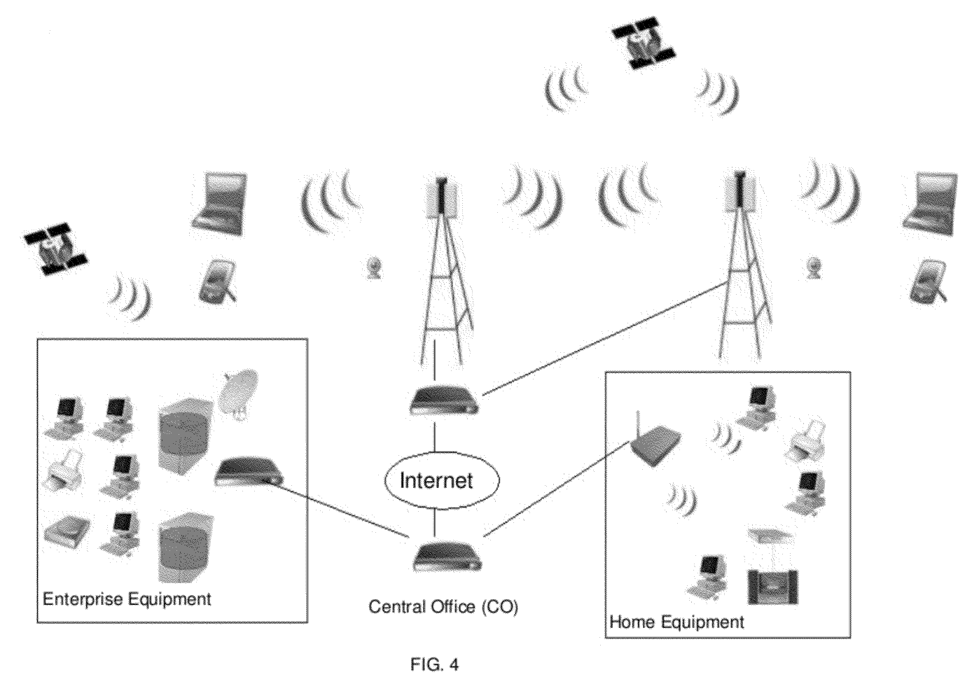

### DIMENSION CHARACTER REPLACEMENTS

With almost any programming language, regular expressions have the power to match and replace characters with multiple encodings. In this case, the method can have a set of two characters, one for matching and one for replacing (a key/value pair). The characters replaced must be case sensitive. For each substitution dimension, the method can have as many characters substituted as feasible, as long as the initial substitution characters do not exist in the previously encoded (encrypted) dimension.

For example, with Perl's expressions, the following describes substituting letters, symbols (escaped) and numbers, globally throughout the encrypted variable.
$Variable=˜s/AΛ%/g;
$Variable=˜s/fΛ@/g;
$Variable=˜s/4/Q/g;
$Variable=˜sΛ=Λ*/g;

When decrypting, each character substitution dimension must reverse each order of the substitution key/value pairs, while the method reverses each dimension order, in the exact reverse order.

There can be multiple substitution key/value pairs for use with “n” number of dimensions. Each set of pairs can be hard-coded within the application, stored as part of an encrypted file, called from a database or other.

### Dimension BASE64 Encoding

Since BASE64, as well as BASE32 and BASE16 encodings can encode binary (and text) data, when applied with a character substitution dimension and the BASE64 encoding for example is not decoded exactly as encoded, the results can be unexpected. The most well known use of BASE64 Encoding is for email. As per RFC 2045, section 6.8: Base64 Content-Transfer-Encoding.

The BASE64 Content-Transfer-Encoding is designed to represent arbitrary sequences of octets in a form that need not be humanly readable. The encoding and decoding techniques (algorithms) are simple, but the encoded data are consistently only about 33 percent larger than the unencoded data. This encoding is virtually identical to the one used in Privacy Enhanced Mail (PEM) applications, as defined in RFC 1421.

A 65-character subset of US-ASCII is used, enabling 6 bits to be represented per printable character. (The extra 65th character, “=”, is used to signify a special processing function). It should be noted that this subset has the important property that it is represented identically in all versions of ISO 646, including US-ASCII, and all characters in the subset are also represented identically in all versions of EBCDIC. Other popular encodings, such as the encoding used by the uuencode utility, Macintosh binhex 4.0 [RFC-1741], and the base85 encoding specified as part of Level 2 PostScript, do not share these properties, and thus do not fulfill the portability requirements a binary transport encoding for mail must meet.

The encoding process represents 24-bit groups of input bits as output strings of 4 encoded characters. Proceeding from left to right, a 24-bit input group is formed by concatenating 3 8-bit input groups. These 24 bits are then treated as 4 concatenated 6-bit groups, each of which is translated into a single digit in the base64 alphabet. When encoding a bit stream via the base64 encoding, the bit stream must be presumed to be ordered with the most-significant-bit first. That is, the first bit in the stream will be the high-order bit in the first 8-bit byte, and the eighth bit will be the low-order bit in the first 8-bit byte, and so on.

Each 6-bit group is used as an index into an array of 64 printable characters.

The character referenced by the index is placed in the output string. These characters, identified in Table 1, below, are selected so as to be universally representable, and the set excludes characters with particular significance to SMTP (e.g., “.”, CR, LF) and to the multipart boundary delimiters defined in RFC 2046 (e.g., “−”).

The foregoing detailed description has set forth a few of the many forms that the invention can take. It is intended that the foregoing detailed description be understood as an illustration of selected forms that the invention can take and not as a limitation to the definition of the invention.

Most preferably, the principles of the invention are implemented as any combination of hardware, firmware and software. Moreover, the software is preferably implemented as an application program tangibly embodied on a program storage unit or computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A multi-purpose, multi-dimensional, variable, and multi-key e-mail and data encryption method comprising:
dynamically encrypting data strings and data files with a set of “n” keys, where n is an integer number greater than 1, and dimensions,
manipulating and encrypting the set of “n” keys, and
using multiple dimensions for preparing the set of “n” keys selected from a group consisting of manipulated environmental variables, manipulated date stamps, and manipulated user data from a database.

2. The method of claim 1, wherein the dimensions use a key to encode binary or text data to a predetermined ASCII alphabet via Cipher Block Chaining.

3. The method of claim 2, wherein the dimensions use regular expressions to replace set characters with set replacements in a set order from a previously encoded initial dimension result.

4. The method of claim 3, wherein the dimensions encode input data to BASE64.

5. The method of claim 4, wherein the dimensions use a manipulated same key/value pair set character substitution on the BASE64 encoded input data.

6. The method of claim 5, wherein the dimensions encode by taking a LIST of values and converting it into a string, using the rules given by a TEMPLATE.

7. The method of claim 6, wherein the dimensions reverse an encoded string.

8. The method of claim 7, wherein an encrypted reverse order key is embedded within an encrypted string or file for transport, using a set of location markers based on string/file length and key length variables.

9. The method of claim 1, wherein at least one dimension is encoded with a key obtained from its local environmental variables such as an IP address, or MAC address, or combination thereof.

10. The method of claim 1, wherein a same first unencrypted character is pre-pended to the encrypted data strings and data files, or placed within the encrypted data strings and data files at a set length marker by a sending application.

11. The method of claim 10, wherein the data strings or files are decoded in reverse order, with the local and remote IP and/or MAC addresses used as keys during the encrypting process.

12. The method of claim 1, wherein random installer keys plus environmental variables are used as keys.

13. A multi-purpose, multi-dimensional, variable, and multi-key e-mail and data decryption method comprising:
using a 1st character to determine an array or character range for common multidimensional decryption of a remainder of multidimensional encrypted data,
extracting and decrypting a length value, encrypted with the character range or array based common dimension hierarchy of an encrypted reverse order dimension mapping key that is pre-pended with a configuration file stored delimiter,
using the decrypted reverse order dimension mapping key and its embedded keys to decrypt the remaining data-set in reverse order, using sending and local IP/MAC addresses and other preset keys and dimensions, and
matching the IP and/or MAC addresses with environmental variables before completing the decryption of the data.

14. A non-transitory computer-readable medium storing a computer program, which, when executed by a computer, cause the computer to:
dynamically encrypt data strings and data files with a set of “n” keys and dimensions, where n is an integer number greater than 1,
manipulate and encrypt the set of “n” keys, and
use multiple dimensions for preparing the set of “n” keys selected from a group consisting of manipulated environmental variables, manipulated date stamps, and manipulated user data from a database.
